(19) United States
(12) Patent Application Publication
(10) Pub. No.: US 2022/0304280 A1
(43) Pub. Date: Sep. 29, 2022

(54) PET TOY

(71) Applicant: Doskocil Manufacturing Company, Inc., Arlington, TX (US)

(72) Inventors: Jill JACKSON, Fort Worth, TX (US); Ronald BAGLEY, Dallas, TX (US); Sunil PINTO, Arlington, TX (US); Josiah WILHELM, Fort Worth, TX (US)

(21) Appl. No.: 17/537,594

(22) Filed: Nov. 30, 2021

Related U.S. Application Data
(60) Provisional application No. 63/164,689, filed on Mar. 23, 2021.

(51) Int. Cl. A01K 15/02

(52) U.S. Cl. CPC A01K 15/026

(57) ABSTRACT

A pet toy includes a central connector with a first engagement structure, a second engagement structure and third engagement structure, an arcuate member having a first end and a second end, the first end being attached to the first engagement structure and the second end being attached to the second engagement structure, and a chewable member attached to the third engagement structure.

### CROSS-REFERENCE TO RELATED APPLICATIONS

This application claims priority to U.S. Provisional Patent Application No. 63/164,689, filed on Mar. 23, 2021. The entire disclosure of which is incorporated herein by reference.

### BACKGROUND

### Field of the Invention

The present invention relates to a pet toy. In particular, the present invention relates to a pet toy that includes a variety of pet toys coupled to a central connector.

### BACKGROUND OF THE INVENTION

There are many types of conventional pet toys that provide various play conditions for a pet. For example, some pet toys enable the pet to chew on the toy or enable the pet to pull against the toy in the user's grip. Many of these toys are configured to allow only a single manner in which users and pets can play.

### SUMMARY

It has been discovered that an improved pet toy that enables a user and a pet to enjoy a variety of play options is desired. In particular, it has been discovered that pet owners or others desire to have a single toy that enables the user to play with their pets in a variety of different ways based on the configuration of the pet toy.

Because many pet toys are limited to one style or manner of play, users may spend less time at play with their pets or find themselves taking multiple pet toys to the play area to allow multiple options of play. Lower time of play can be detrimental to users and pets alike because it leads to less active exercise time. Taking multiple pet toys to the play area increases the chance that the user or pet will end up losing one of the pet toys or will overplay or underplay with the pet based on the variety (or lack of variety) of toys. Therefore, a pet toy that satisfies multiple play options will enable a user to bring a single toy to a play area, enable proper play time, and reduce the possibility of losing track of toys.

Additionally, it has been discovered that retail stores have limited space for all items, including pet toys. Retail stores must choose which pet toys to display and the limited space may create a lower number of toy and play options. Therefore, a pet toy that satisfies multiple play options will enable a retailer to carry one toy that can be used for multiple activities.

Further, many users complain about a lack of durability of conventional pet toys which undergo a great deal of stress, especially chewing and pulling toys. Therefore, a pet toy that is resilient can improve the durability of the toy and last longer.

The embodiments of the pet toy described herein satisfy the issues discovered with conventional pet toys and result in an improved multi-play pet toy. In view of the state of the known technology, a first aspect of the present disclosure is to provide a pet toy including a central connector with a first engagement structure, a second engagement structure and third engagement structure, an arcuate member having a first end and a second end, the first end being attached to the first engagement structure and the second end being attached to the second engagement structure, and a chewable member attached to the third engagement structure.

In a second aspect of the pet toy according to the first aspect, each of the first, second and third engagements structures are threaded openings.

In a third aspect of the pet toy according to the first or second aspect, the arcuate member is a flexible rope.

In a fourth aspect of the pet toy according to any of the previous aspects, the first and second ends of the arcuate member are detachably attached to the first and second engagement structures, respectively.

In a fifth aspect of the pet toy according to any of the previous aspects, the chewable member is detachably attached to the third engagement structure.

In a sixth aspect of the pet toy according to any of the previous aspects, the chewable member is a faux suede pouch.

In a seventh aspect of the pet toy according to any of the previous aspects, the chewable member contains a squeaking device.

In an eighth aspect of the pet toy according to any of the previous aspects, a chewable ring is moveably disposed around the arcuate member.

In a ninth aspect of the pet toy according to any of the previous aspects, the chewable ring includes teething nubs.

In a tenth aspect of the pet toy according to any of the previous aspects, a polygonal structure is moveably disposed around the arcuate member.

In an eleventh aspect of the pet toy according to any of the previous aspects, the polygonal structure is a faux suede hexagon.

In a twelfth aspect of the pet toy according to any of the previous aspects, an angle between a central axis of each adjacent engagement structure is about 120 degrees.

In a thirteenth aspect of the pet toy according to any of the previous aspects, the central connector is formed from molded rubber.

These embodiments of the pet toy provide a variety of chewing textures all in one device. In fact the pet toy described herein can provide four toys within a single toy. This advantage prevents a user from having to buy several toys at once for a new puppy.

### BRIEF DESCRIPTION OF THE DRAWINGS

The invention will be explained in more detail hereinafter with reference to the drawings.

FIG. 1 illustrates a pet toy in accordance with an embodiment of the present invention;

FIG. 2 is a side elevantional view of the pet toy of FIG. 1;

FIG. 3 is a top view of the pet toy of FIG. 1;

FIG. 4 is an exploded of the pet toy of FIG. 1;

FIG. 5 is an exploded view in section of the pet toy of FIG. 4; and

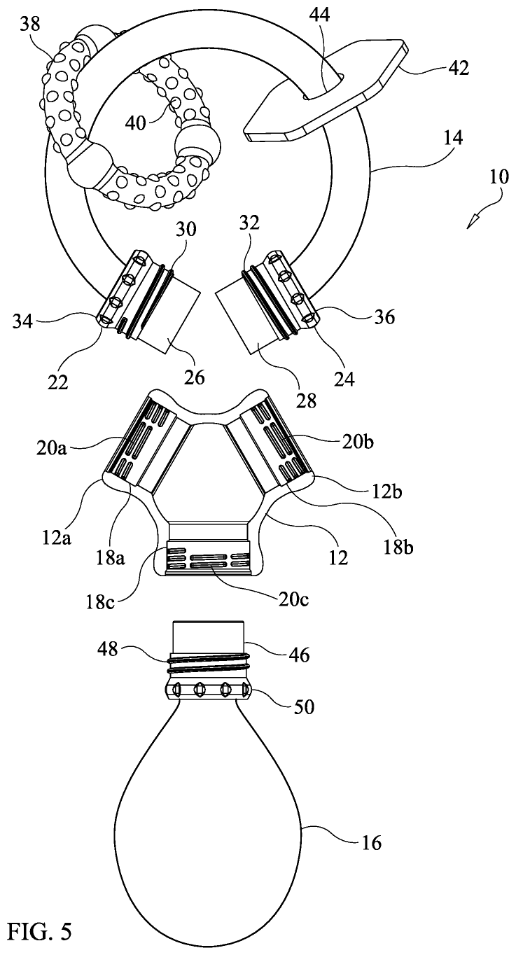

FIG. 6 is a cross sectional view of the pet toy illustrated in FIG. 4.

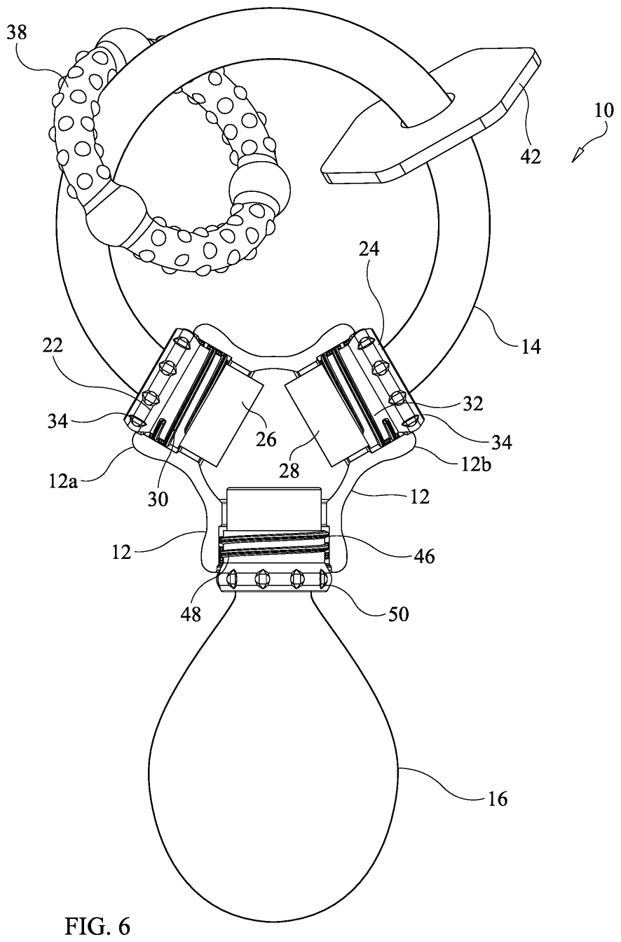

### DETAILED DESCRIPTION OF THE EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

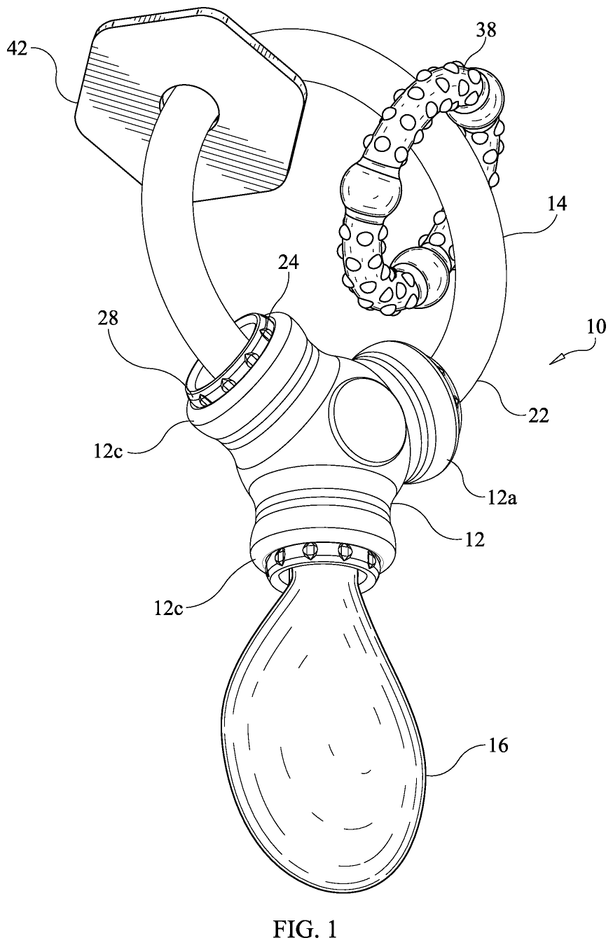

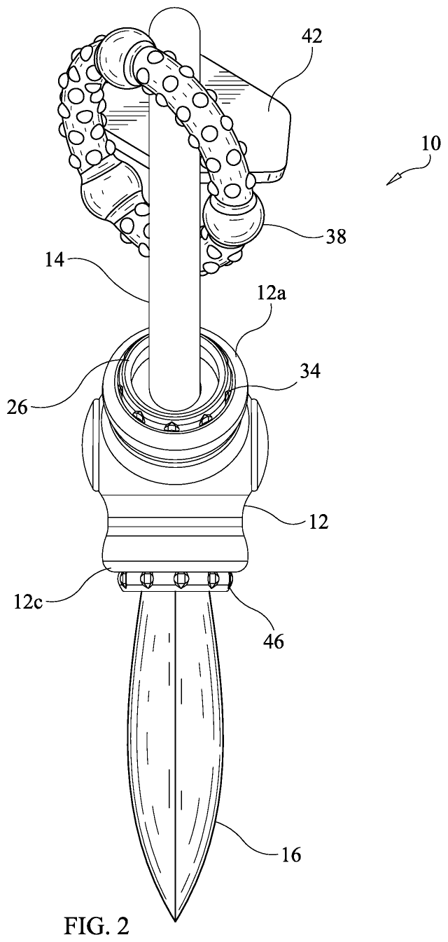

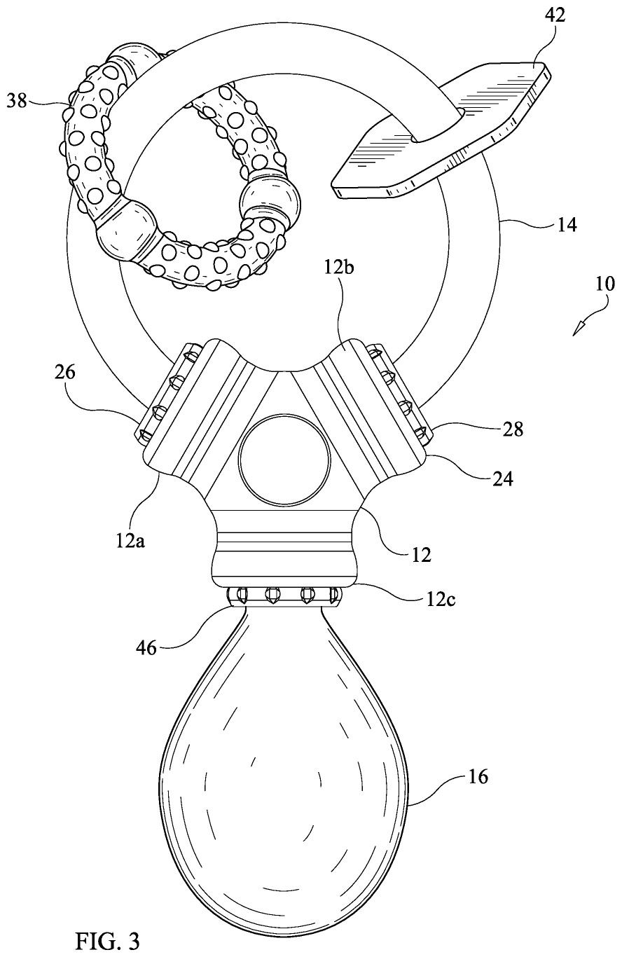

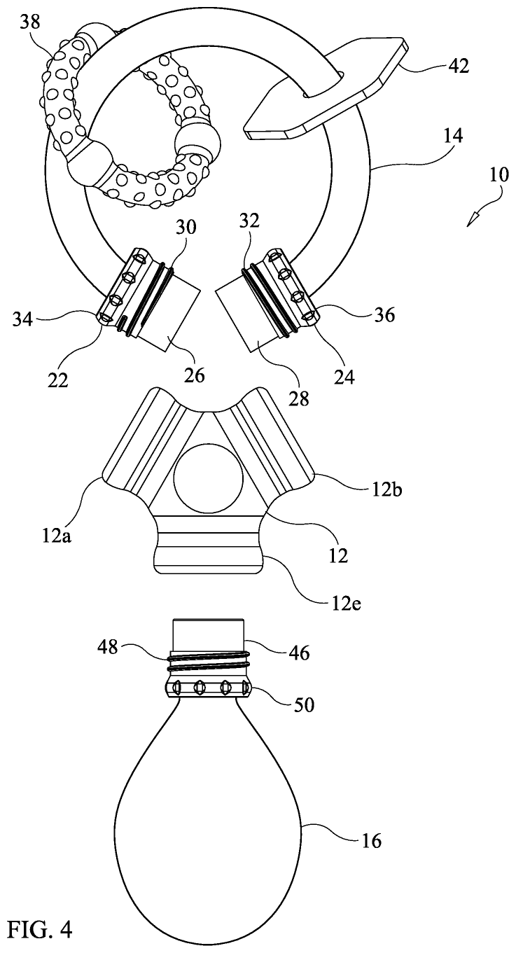

Referring initially to FIGS. 1-4, a pet toy 10 is illustrated in accordance with an embodiment. The pet toy 10 includes a central connector 12, an arcuate member 14 and a chewable member 16.

The central connector 12 (central hub) is preferably rubber or any suitable thermo plastic or plastic, or can be any suitable durable material. As can be understood, the pet toy 10 will likely be subject to chewing by an animal and thus the material should be somewhat resilient to prevent destruction of the toy due to prolonged chewing by an animal, such as a dog.

The central connector 12 is generally triangular in shape and includes a first engagement structure 12a, a second engagement structure 12b and a third engagement structure 12c. Each of the engagement structures 12a-12c are equally spaced from each other. In other words, the angle between the central axis of each adjacent engagement structure is about 120 degrees.

The engagement structures 12a-12c are preferably circular openings or blind bores 18a-18c with threads 20a-20c disposed on an internal surface of each of the circular openings. Each of the engagement structures 12a-12c preferably has a similar internal diameter, such that any attachments can be interchangeable within the engagement structures 12a-12c. However, it is noted that the engagement structures 12a-12c can be any suitable engagement structure and can have differing internal diameters.

The arcuate member 14 is preferably a flexible braided rope. However, the arcuate member 14 can be formed from any material desired and can be flexible, rigid, semi-rigid and/or pliable. The arcuate member 14 has a first end 22 and a second end 24, the first end 22 being attached to the first engagement structure 12a and the second end 24 being attached to the second engagement structure 12b. The ends 22 and 24 of the arcuate member 14 include first and second connectors 26 and 28 (pouch connectors), respectively, the connectors 26 and 28 at the ends 22 and 24 of the arcuate member 14 are preferably plastic molded members. The connectors 26 and 28 can be generally cylindrical with threads 30 and 32 on an external surface thereof. The external threads 30 and 32 on the connectors 26 and 28 correspond to the threads 20a-20c on the internal surface of the engagement structures 12a-12c. Thus, the connectors 26 and 28, when coupled to the central connector 12 are generally completely or at least mostly disposed within the engagement structures 12a-12c, such that the connectors 26 and 28 are not subject to chewing by an animal.

In one embodiment, the connectors 26 and 28 include radial ring portions 34 and 36 that are disposed externally relative to the engagement structures 12a-12c to enable easy removal of the attachment structure connected to the connector 12 (e.g., the arcuate member 14). As can be understood, the radial ring portions 34 and 36 have an external diameter that is greater than the diameter of the outer surface of the connector 26 and 38 on which the threads 30 and 32 are disposed. Thus, a user can easily grip the radial ring portion 34 or 36 so as to be able to twist and unscrew the connectors 26 and 28. However, the external diameter of the radial ring portions 34 and 36 can be less than the external diameter of the engagement structure 12a-12c. As can be understood, since the external diameter of the radial ring portions 34 and 36 can be less than the external diameter of the engagement structure 12a-12c, the radial ring portions 34 and 36 can be difficult to access for an animal and thus is less likely to be subject to chewing by an animal.

In one embodiment, the pet toy 10 can include a chewable ring 38 moveably disposed around the arcuate member 14. The chewable ring 38 defines a central opening 40 that has an internal diameter that is greater than the outer diameter of the arcuate member 14. Thus, the chewable member 16 is capable of sliding along the arcuate member 14. In one embodiment, the chewable ring 38 is a molded ring formed from TPR and includes teething nubs. However, it is noted that the chewable ring 38 can be formed in any manner desired and of any material desired. As with the other structures described herein, it is preferable that the chewable ring 38 be formed from a material that is somewhat resilient to prevent destruction of the toy due to prolonged chewing by an animal, such as a dog.

In one embodiment, the pet toy 10 can include a polygonal structure 42 moveably disposed around the arcuate member 14. The polygonal structure 42 defines a central opening 44 that has an internal diameter that is greater than the outer diameter of the arcuate member 14. Thus, the polygonal structure 42 is capable of sliding along the arcuate member 14. In one embodiment, the polygonal structure 42 is a faux suede hexagon. However, it is noted that the polygonal structure 42 can be formed in any manner desired and of any material desired. As with the other structures described herein, it is preferable that the polygonal structure 42 be formed from a material that is somewhat resilient to prevent destruction of the toy due to prolonged chewing by an animal, such as a dog.

The chewable member 16 can be attached to the third engagement structure 12c. In one embodiment the chewable member 16 is a faux suede pouch. Additionally, the chewable member 16 can contain a squeaking device (not shown). However, it is noted that the chewable member 16 can be formed in any manner desired and of any material desired. As with the other structures described herein, it is preferable that the chewable member 16 be formed from a material that is somewhat resilient to prevent destruction of the toy due to prolonged chewing by an animal, such as a dog.

Further, attached at one end, the chewable member 16 can have a connector 46. The connector 46 can be generally cylindrical with threads 48 on an external surface thereof. The external threads 48 on the connector 46 correspond to the threads 20q-c on the internal surface of the engagement structures 12a-12c. Thus, the 46, when coupled to the central connector 12 is generally completely or at least mostly disposed within the engagement structures 12a-12c, such that the connector 46 is not subject to chewing by an animal.

In one embodiment, the connector 46 includes a radial ring portion 50 that is disposed externally relative to the engagement structure 12c to enable easy removal of the attachment structure connected to the connector 46 (e.g., the chewable member 16). As can be understood, the radial ring portion 50 has an external diameter that is greater than the diameter of the outer surface of the connector 46 on which the threads 48 are disposed. However, the external diameter of the radial ring portion 50 can be less than the external diameter of the engagement structure 12c. As can be understood, since the external diameter of the radial ring portion 50 can be less than the external diameter of the engagement structure 12c, the radial ring portion 50 can be difficult to access for an animal and thus is less likely to be subject to chewing by an animal.

It is noted that the arcuate member 14 and the chewable member 16 can be replaced with additional or other structures for the animal to play with or chew.

Embodiments of the pet toy 10 described herein provide a variety of chewing textures all in one device. In fact the pet toy 10 described herein can provide four toys within a single toy. This advantage prevents a user from having to buy several toys at once for a new puppy or other animal.

### General Interpretation of Terms

In understanding the scope of the present invention, the term “comprising” and its derivatives, as used herein, are intended to be open ended terms that specify the presence of the stated features, elements, components, groups, and/or steps, but do not exclude the presence of other unstated features, elements and components, groups. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Accordingly, these terms, as utilized to describe the present invention should be interpreted relative to the pet toy.

The terms of degree such as “about” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. The functions of one element can be performed by two, and vice versa. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed:

1. A pet toy comprising:
a central connector with a first engagement structure, a second engagement structure and third engagement structure;
an arcuate member having a first end and a second end, the first end being attached to the first engagement structure and the second end being attached to the second engagement structure; and
a chewable member attached to the third engagement structure.

2. The pet toy according to claim 1, wherein each of the first, second and third engagements structures are threaded openings.

3. The pet toy according to claim 1, wherein the arcuate member is a flexible rope.

4. The pet toy according to claim 1, wherein the first and second ends of the arcuate member are detachably attached to the first and second engagement structures, respectively.

5. The pet toy according to claim 1, wherein the chewable member is detachably attached to the third engagement structure.

6. The pet toy according to claim 1, wherein the chewable member is a faux suede pouch.

7. The pet toy according to claim 1, wherein the chewable member contains a squeaking device.

8. The pet toy according to claim 1, further comprising a chewable ring moveably disposed around the arcuate member.

9. The pet toy according to claim 8, wherein the chewable ring includes teething nubs.

10. The pet toy according to claim 1, further comprising a polygonal structure moveably disposed around the arcuate member.

11. The pet toy according to claim 10 wherein the polygonal structure is a faux suede hexagon.

12. The pet toy according to claim 1, wherein an angle between a central axis of each adjacent engagement structure is about 120 degrees.

13. The pet toy according to claim 1, wherein the central connector is formed from molded rubber.

14. A pet toy comprising:
a central connector with a first threaded opening, a second threaded opening and a third threaded opening;
a flexible member having a first end and a second end, the first end being detachably attached to the first threaded opening and the second end being detachably attached to the second threaded opening; and
a chewable member detachably attached to the third threaded opening.

15. The pet toy according to claim 14, further comprising a chewable ring moveably disposed around the flexible member.

16. The pet toy according to claim 14, wherein an angle between a central axis of each adjacent threaded opening is about 120 degrees.
